(19) United States
(12) Patent Application Publication
(10) Pub. No.: US 2003/0178897 A1
(43) Pub. Date: Sep. 25, 2003

(54) Stepping motor

(75) Inventor: Chang Keun Jun, Shihung (KR)

Correspondence Address: DARBY & DARBY P.C., 805 Third Avenue, New York, NY, 10022, US

(73) Assignee: SAMSUNG ELECTRO MECHANICS CO., LTD., Suwon-Shi (KR)

(21) Appl. No.: 10/323,107

(22) Filed: Dec. 19, 2002

(30) Foreign Application Priority Data
Mar. 25, 2002 (KR) 2002-16168

(51) Int. Cl. H02K 5/16; H02K 7/08; H02K 37/00

(52) U.S. Cl. 310/90; 310/49 R

(57) ABSTRACT

The invention relates to a stepping motor having a structure capable of stably supporting a rotary shaft thereby to maintain stable erectness as well as reduce noise and vibration.

### BACKGROUND OF THE INVENTION

1. Field of the Invention

The present invention relates to a stepping motor, in particular, which can reduce vibration and noise while stably maintaining the axial erectness of a rotary shaft.

2. Description of the Prior Art

In general, a stepping motor can rotate at a given angle without a feedback for detecting the position of a rotary shaft and stop with a considerably high precision, and when stopped, maintains a very large amount of static torque compared to other motors. The stepping motor does not need any separate position-maintaining mechanism such as an electromagnetic brake. Also, the rotation speed of the stepping motor is proportional to pulse rate. Accordingly, the stepping motor can be readily controlled as operational characteristics thereof.

Due to such characteristics, the stepping motor is generally used for precision control of mechanical movement. In particular, the stepping motor is widely used as a driving source of a small-sized precise electronic device since it can be controlled digitally via pulse.

For example, the stepping motor is used as a driving source for controlling the printing position of a print head, the pen position of an X-Y plotter or the head position of a floppy disk and various disk ROMs. The stepping motor is also used in precisely controlling various electronic instruments such as paper money counter, sewing machine, electric typewriter and facsimile.

FIG. 1 is a schematic sectional view illustrating a stepping motor of the prior art. As shown in FIG. 1, the stepping motor mainly comprises a rotor and a stator.

The rotor includes a rotary shaft 100 and a magnet 150. The rotary shaft 100 has one end rotatably inserted into a central portion of the stator 200. The other end of the rotary shaft 100 has a screw 100s formed in an outer periphery thereof.

The one end of the rotary shaft 100 is supported by a metal bearing b in a rotatable manner in forward and reverse directions within the stator 200. The lead screw 100s is formed in the other end of the rotary shaft 100 to axially carry a transport member (not shown) and the like. A magnet 150 is integrally and rotatably coupled with an outer periphery of the one end of the rotary shaft 100 in the stator 200. The magnet 150 is substantially cylinder-shaped, and has alternately magnetized N and S poles.

Coils 230 and 260 placed in an inner periphery of the stator 200 are disposed opposite to the magnet 150 at a predetermined gap therefrom so as to generate electromagnetic force owing to interaction between the coils 230 and 260 and the magnet 150.

The stator 200 includes first and second yokes 210 and 240, which are axially arranged around the rotary shaft 100. The cylindrical coils 230 and 260 are wound, respectively, within the yokes 210 and 240.

That is, a bobbin 220 is disposed within the first yoke 210, and the coil 230 is wound around an outer surface of a bobbin 220. The yoke is alternatingly arranged in a meshing configuration within the stator, as opposed to the magnet 150 of the rotor.

Like the first yoke 210, a bobbin 250 is disposed within the second yoke 240, and the coil 260 is wound around the bobbin 250. The yoke is alternatingly arranged in a meshing configuration within the stator, as opposed to the magnet 150 of the rotor.

The first and second yokes 210 and 240 configured as above are integrally fixed by first and second covers c1 and c2.

In the conventional stepping motor as above, the rotary shaft 100 is provided at both ends with V-shaped grooves 110 and 120 for receiving balls 130 and 140, which are supported by a leaf spring 270 and a holder 280, respectively.

That is, the one end of the rotary shaft 100 is supported by the ball 130, which is elastically supported by the leaf spring 270 while the other end of the rotary shaft 100 is fixed by the holder 280 with the ball 140 interposed therebetween.

The above construction allows the rotary shaft 100 to be under elastic support in an axial direction thereby compensating an error in assembly tolerance as well as an additional transport member (not shown) to perform forward and reverse motion thereby absorbing thrust load applied during transportation.

In the conventional stepping motor as set forth above, however, since the leaf spring 270 does not locate itself in the center of the ball 130 as shown in FIG. 1 and obliquely contacts the ball 130 at an angle, rotation of the rotary shaft 100 causes the leaf spring 270 to slightly vibrate in a direction to the central axis. The above phenomenon further increases when the stepping motor rotates with the transport member (not shown) being loaded on the lead screw 100s of the rotary shaft 100. As a result, noise and vibration are generated as well as the erectness of the rotary shaft is unstabilized, thereby deteriorating operative features.

### SUMMARY OF THE INVENTION

The present invention has been made to solve the foregoing problems of the prior art and it is therefore an object of the invention to provide a stepping motor having a structure capable of stably supporting a rotary shaft thereby to maintain stable erectness as well as reduce noise and vibration.

According to an aspect for achieving the above object, the invention provides a stepping motor comprising: a housing having a stator therein, the stator including a coil and a yoke, and one end coupled with a cover plate; a rotary shaft having a first portion inserted into the stator of the housing, a second portion exposed out of the stator and with a lead screw formed in an outer periphery thereof, and first and second global portions shaped as a semi-globe at both ends thereof; a holder for performing point contact with the second global portion of the rotary shaft; a bracket for fixing the holder; a first guide hole perforated in the housing on a line extended from the rotary shaft to the first global portion; a thrust guide fixed within the housing, and having a second guide hole perforated in a position corresponding to the first guide hole at a distance therefrom; a thrust bearing having both ends movably inserted into the first and second guide holes, and performing point contact with the first global portion of the rotary shaft; and an elastic member arranged in the thrust bearing for applying elastic force to the thrust bearing so that the thrust bearing elastically supports the first global portion.

It is preferred that the thrust bearing has a dent portion, wherein the first global portion of the rotary shaft is inserted into the dent portion to perform point contact therewith.

It is also preferred that the thrust bearing has a flange in a central outer periphery which does not contact with the first or second guide hole.

It is preferred that the elastic member comprises a spring washer which has a central through-hole corresponding to the first guide hole and an outer periphery contacting with an inner surface of the housing, wherein the through-hole has a periphery contacting with one end of the thrust bearing for applying elastic force thereto.

Also it is preferred that the thrust bearing has a fitting groove in a central outer periphery which does not contact with the first or second guide hole, the fitting groove being adapted to catch one end of the elastic member.

According to another aspect for achieving the above object, the invention provides a stepping motor comprising: a housing having a stator therein, the stator including a coil and a yoke, and one end coupled with a cover plate; a rotary shaft having a first portion inserted into the stator of the housing, a second portion exposed out of the stator and with a lead screw formed in an outer periphery thereof, and first and second global portions shaped as a semi-globe at both ends thereof; a holder arranged in a portion of the rotary shaft where the lead screw is formed, and for performing point contact with the second ball; a bracket for fixing the holder; a first guide hole perforated in the housing on a line extended from the rotary shaft to the first global portion; a thrust guide fixed within the housing, and having a second guide hole perforated in a position corresponding to the first guide hole at a distance therefrom; a thrust bearing having both ends movably inserted into the first and second guide holes, and performing point contact with the first global portion of the rotary shaft; and an elastic member arranged in the thrust bearing for applying elastic force to the thrust bearing so that the thrust bearing elastically supports the first global portion.

It is preferred that the thrust bearing has a dent portion, wherein the first global portion of the rotary shaft is inserted into the dent portion to perform point contact therewith.

It is also preferred that the thrust bearing has a flange in a central outer periphery which does not contact with the first or second guide hole.

It is preferred that the elastic member comprises a spring washer which has a central through-hole corresponding to the first guide hole and an outer periphery contacting with an inner surface of the housing, wherein the through-hole has a periphery contacting with one end of the thrust bearing for applying elastic force thereto.

According to further another aspect for achieving the above object, the invention provides a stepping motor comprising: a cylindrical magnet; a rotary shaft coupled, at one end, with a center of the cylindrical magnet, and having a lead screw in a portion adjacent to the other end; a having a coil and a yoke and surrounded by a housing and a cover plate, the stator rotatably supporting the rotary shaft in a central portion thereof via a bearing; a first guide hole perforated in the housing corresponding to an axial line of the rotary shaft; a thrust bearing having upper and lower ends movably inserted into the first and second guide holes, respectively, the lower end having a dent portion performing point contact with a terminal end of the rotary shaft; and a spring washer having one end supported to the housing and the other end supported to the thrust bearing so that the thrust bearing elastically presses the rotary shaft.

It is preferred that the thrust bearing has a flange in a central outer periphery thereof, the flange being adapted to catch the other end of a spring washer.

### BRIEF DESCRIPTION OF THE DRAWING

FIG. 1 is a schematic sectional view showing a construction of a stepping motor of the prior art;

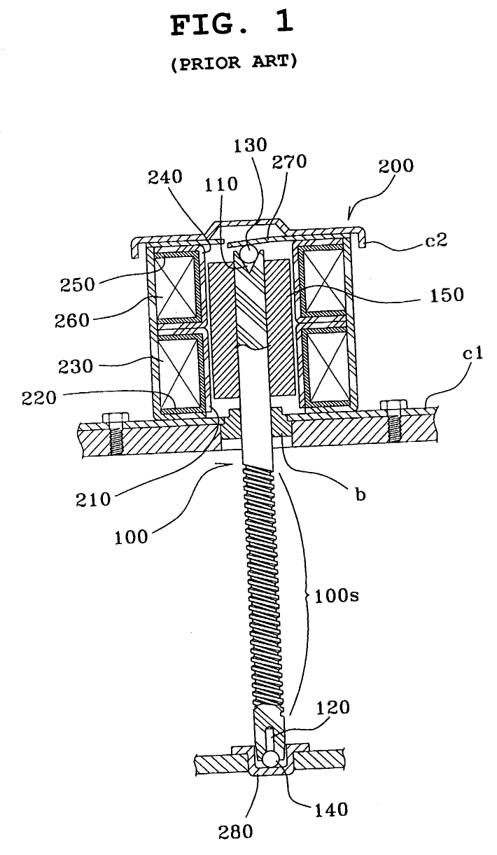

FIG. 2 is a sectional view showing a construction of a stepping motor according to a preferred embodiment of the invention;

FIG. 3 is an exploded perspective view of important parts of the stepping motor of the invention; and

FIG. 4 is a sectional view of an alternative embodiment of the invention; and

FIG. 5 is a sectional view of another alternative embodiment of the invention.

### DESCRIPTION OF THE PREFERRED EMBODIMENTS

The following detailed description of the invention will discuss preferred embodiments of the present invention in reference to the accompanying drawings.

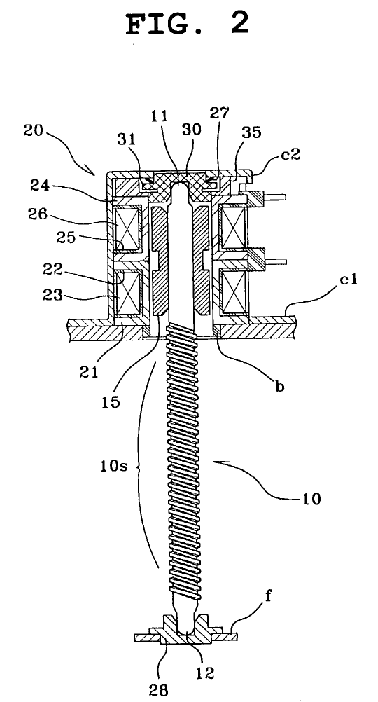

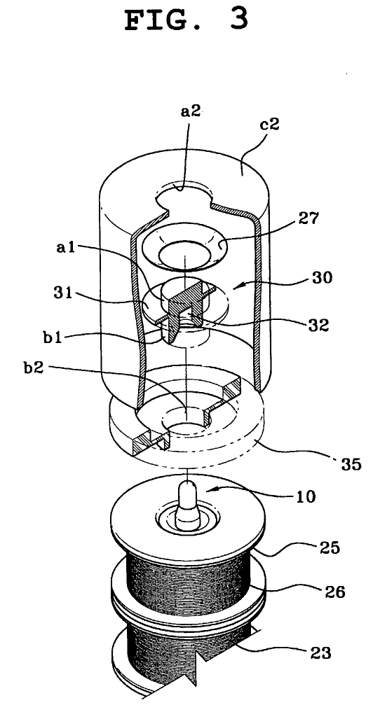

FIG. 2 is a sectional view showing a construction of a stepping motor according to a preferred embodiment of the invention, and FIG. 3 is an exploded perspective view of important parts of the stepping motor of the invention.

As shown in FIGS. 2 and 3, the stepping motor has a stator 20 in an internal space defined by a substantially cylindrical housing c2 and a cover plate c1. The stator 20, includes first and second yokes 21 and 24, which are axially arranged around a rotary shaft 10. The first yoke 21 has a bobbin 22 therein and a coil 23 wound around an outer surface of the bobbin 22 within the yoke. The second yoke 24 has a bobbin 25 therein and a coil 26 wound around an outer surface of the bobbin 25 within the yoke 24.

A rotary shaft 10 has one end, which is rotatably inserted into a central portion of the stator 20 via a metal bearing b. The rotary shaft 10 also includes one portion inserted into the stator 20 and another portion exposed out of the stator 20 which is exposed out of the stator 20 and has a lead screw 10s for axially carrying a transport member.

A cylindrical magnet 15 is integrally coupled to an outer periphery of the rotary shaft 10 which is inserted into the stator 20. The magnet 15 is opposed to the coils 23 and 26 of the foregoing first and second yokes 21 and 24 at a predetermined gap so as to generate electromagnetic force owing to interaction between the magnet 15 and the coils 23 and 26.

The rotary shaft 10 has first and second global portions 11 and 12 at both ends thereof. The lead screw 10s is formed adjacent to the second global portion 12, i.e., the end of the rotary shaft 10. A holder 28 performs point contact with the second global portion 12, and a bracket f for fixedly supporting the holder 28 is mounted on the second global portion 12.

The first global portion 11 of the rotary shaft 10 is under elastic support of an elastic support means, and thus maintains an elastically pressed-down position when seen in the drawing.

The elastic support means includes a first guide hole a2, a thrust guide 35, a thrust bearing 30 and an elastic member.

The first guide hole a2 is a through-hole defined in an upper side of the housing c2, and positioned on a line extended from the first global portion 11 of the rotary shaft 10.

The thrust guide 35 is placed at a predetermined distance from one side of the housing c2 having the above guide hole a2. The thrust guide 35 has a second guide hole b2 in a position corresponding to the first guide hole a2. An outer periphery of the thrust guide 35 contacts with an inner surface of the housing c2, thereby fixing the thrust guide 35 in position.

The substantially cylindrically shaped thrust bearing 30 has upper and lower ends a1 and b1, which are movably inserted into the first and second guide holes a2 and b2. A dent portion 32 shaped as a concave groove is formed in a lower end 1 of the thrust bearing 30. The first global portion 11 of the rotary shaft 10 is inserted into the dent portion 32 performing point contact with the dent portion 32. The thrust bearing 30 also has, at a central outer periphery thereof, a flange 31 which does not contact with the first or second guide hole a2 or b2.

Based upon the flange 31, the upper end a1, i.e., an upper portion of the thrust bearing 30, is inserted into the first guide hole a2 and guided thereby. The lower end b1 of the thrust bearing 30 is inserted into the second guide hole b2 and guided thereby.

The thrust bearing 30 configured as above elastically supports the rotary shaft 10 downward. The elastic member is in the form of a spring washer 27. The spring washer 27 has an outer periphery, which is supported by an inner surface of the housing c2 having the first guide hole a2, and an inner periphery of a central through-hole, which contacts with an upper surface of the flange 31 of the thrust bearing 30 so as to elastically support the thrust bearing 30 downward.

Alternatively, the thrust bearing 30 has a supporting structure of the spring washer 27 which may be variously modified without consideration of a projected structure, i.e., the flange 31.

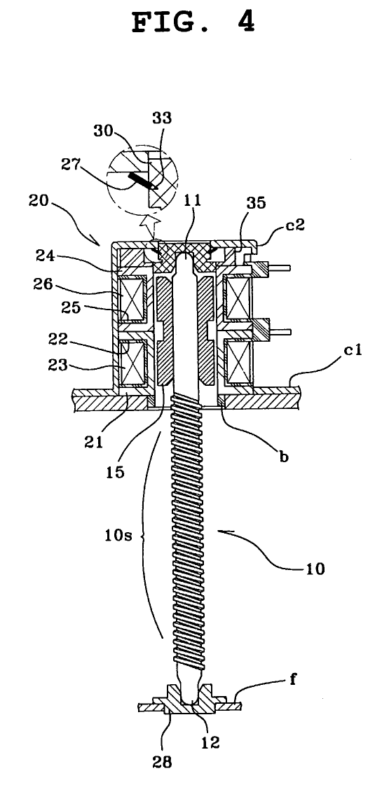

For example, as shown in FIG. 4, the thrust bearing 30 can have a fitting groove 33 for catching one end of the spring washer 27. The fitting groove 33 is defined by recessing a central outer periphery of the thrust bearing 30 which does not contact with the first or second guide holes a2 or b2.

In the stepping motor having the above construction, the first global portion 11 of the rotary shaft 10 is supported by the thrust bearing 30 in a surrounding manner, in which the thrust bearing 30 is inserted into the first and second guide holes a2 and b2 and guided thereby while being uniformly supported by the spring washer 27 serving as the elastic member so as to axially support the rotary shaft 10 in a uniform and stable elastic fashion.

In particular, since the first guide hole a2 is spaced from the second guide hole b2, the thrust bearing 30 has a guide section which is increased over that of a conventional one. The increased guide section allows stable movement to the rotary shaft 10.

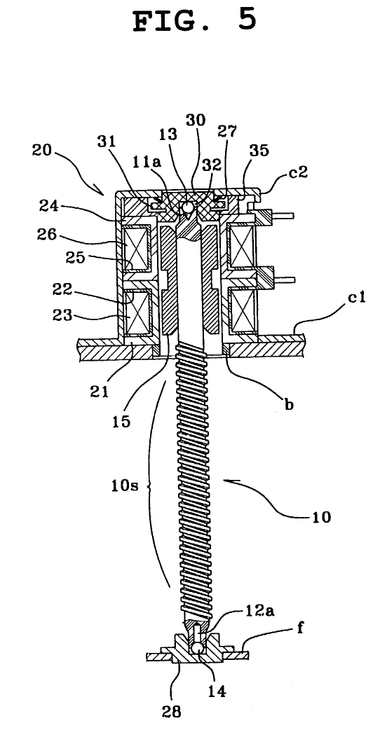

FIG. 5 is a sectional view of an another alternative embodiment of the invention.

As shown in FIG. 5, the stepping motor comprises a stator 20 in an internal space defined by a substantially cylindrically shaped housing c2 and a cover plate c1. The stator 20 includes first and second yokes 21 and 24 which are axially arranged around a rotary shaft 10. The first yoke 21 has a bobbin 22 therein and a coil 23 wound around an outer surface of the bobbin 22 within the yoke. The second yoke 24 has a bobbin 25 therein and a coil 26 wound around an outer surface of the bobbin 25 within the yoke 24.

The rotary shaft 10 has one end, which is rotatably inserted into a central portion of the stator 20 via a metal bearing b. The rotary screw 10 also includes one portion inserted into the stator 20 and another portion, which is exposed out of the stator 20 and has a lead screw 10s for axially carrying a transport member.

A cylindrical magnet 15 is integrally coupled to an outer periphery of the rotary shaft 10 inserted into the stator 20. The magnet 15 is opposed to the coils 23 and 26 of the foregoing first and second yokes 21 and 24 at a predetermined gap so as to generate electromagnetic force owing to interaction between the magnet 15 and the coils 23 and 26.

The rotary shaft 10 has first and second grooves 11a and 12a at both ends thereof. The first and second grooves 11a and 12a are substantially V-shaped, and have first and second balls 13 and 14 therein, respectively. At the lower end of the rotary shaft 10, i.e., one end of a shaft portion having the lead screw 10s, the second ball 14 performs point contact with a holder 28 and a bracket f fixedly supports the holder 28.

An elastic support means elastically supports the upper end, i.e., the other end of the rotary shaft 10 where the first ball 13 is placed so as to maintain the rotary shaft 10 in an elastically downward-pressed position when seen in FIG. 5.

That is, the elastic support means includes a first guide hole a2, a thrust guide 31, a thrust bearing 30 and an elastic member. The first guide hole a2 is a through-hole perforated in one side of the housing c2, and positioned on an axial line extended from the rotary shaft 10.

A thrust guide 35 is arranged at a predetermined distance from one side of the housing c2 having the first guide hole a2. The thrust guide 35 has a second guide hole b2 which is perforated in a position corresponding to the first guide hole a2. An outer periphery of the thrust guide 35 contacts with an inner surface of the housing c2 to fix the thrust guide 35 in position.

The substantially cylindrically shaped thrust bearing 30 has upper and lower ends a1 and b1 which are movably inserted into the first and second guide holes a2 and b2. A dent portion 32 shaped as a concave groove is formed in a lower end of the thrust bearing 30. A first ball 13 received in the first groove 11a is inserted into the dent portion 32 to perform point contact with the dent portion 32. The thrust bearing 30 also has, at a central outer periphery thereof, a flange 31 which does not contact with the first or second guide hole a2 or b2.

Based upon the flange 31, the upper end a1, i.e., an upper portion of the thrust bearing 30 is inserted into the first guide hole a2 and guided thereby. The lower end b1 of the thrust bearing 30 is inserted into the second guide hole b2 and guided thereby.

The thrust bearing 30 configured as above elastically supports the rotary shaft 10 downward. The elastic member is in the form of a spring washer 27. The spring washer 27 has an outer periphery, which is supported by an inner surface of the housing c2 having the first guide hole a2, and an inner periphery of a central through-hole, which contacts with an upper surface of the flange 31 of the thrust bearing 30 so as to elastically support the thrust bearing 30 downward.

In the stepping motor constructed as above, the first ball 13 received in the first groove 11a of the rotary shaft 10 is inserted into the dent portion of the thrust bearing 30 to perform point contact. The thrust bearing 30 is inserted into the first and second guide holes a2 and b2 and guided thereby while being uniformly supported by the spring washer 27 in an axial direction so as to axially support the rotary shaft 10 in a uniform and stable elastic fashion.

In particular, since the first guide hole a2 is spaced from the second guide hole b2, the thrust bearing 30 has a guide section which is increased over that of a conventional bearing, thereby ensuring stable movement to the rotary shaft 10.

It should be construed that the foregoing embodiments of the present invention have been described for illustrative purposes only. Rather, applications of the present invention can properly varied without departing the spirit and scope of the present invention. For example, it is possible to make various modifications to the foregoing shape and construction shown in the embodiments of the invention.

The stepping motor of the invention constructed and applied as above provides advantages in that the thrust bearing is inserted into the thrust guide and axially guided while being elastically supported by the spring washer so that the rotary shaft is uniformly and elastically supported so as to reduce vibration and noise which are generated in rotation of the rotary shaft by large amounts.

Further, the thrust bearing contacts respectively with the thrust guide and the housing and slides thereon, and thus can maintain a stably balanced position when it precisely moves in an axial direction in rotation of the rotary shaft, thereby reducing the possibility of noise creation.

In particular, the elastic force of the spring washer is precisely applied to a central portion of the rotary shaft so as to improve the erectness of the rotary shaft over that of a convention one, resultantly ensuring stable operative features of the motor.

What is claimed is:

1. A stepping motor comprising:
a housing having a stator therein, the stator including a coil and a yoke, and one end coupled with a cover plate;
a rotary shaft having a first portion inserted into the stator of the housing, a second portion exposed out of the stator and with a lead screw formed in an outer periphery thereof, and first and second global portions shaped as a semi-globe at both ends thereof;
a holder for performing point contact with the second global portion of the rotary shaft;
a bracket for fixing the holder;
a first guide hole perforated in the housing on a line extended from the rotary shaft to the first global portion;
a thrust guide fixed within the housing, and having a second guide hole perforated in a position corresponding to the first guide hole at a distance therefrom;
a thrust bearing having both ends movably inserted into the first and second guide holes, and performing point contact with the first global portion of the rotary shaft; and
an elastic member arranged in the thrust bearing for applying elastic force to the thrust bearing so that the thrust bearing elastically supports the first global portion.

2. The stepping motor in accordance with claim 1, wherein the thrust bearing has a dent portion, wherein the first global portion of the rotary shaft is inserted into the dent portion to perform point contact therewith.

3. The stepping motor in accordance with claim 1, wherein the thrust bearing has a flange in a central outer periphery which does not contact with the first or second guide hole.

4. The stepping motor in accordance with claim 1, wherein the elastic member comprises a spring washer which has a central through-hole corresponding to the first guide hole and an outer periphery contacting with an inner surface of the housing, wherein the through-hole has a periphery contacting with one end of the thrust bearing for applying elastic force thereto.

5. The stepping motor in accordance with claim 1, wherein the thrust bearing has a fitting groove in a central outer periphery which does not contact with the first or second guide hole, the fitting groove being adapted to catch one end of the elastic member.

6. A stepping motor comprising:
a housing having a stator therein, the stator including a coil and a yoke, and one end coupled with a cover plate;
a rotary shaft having a first portion inserted into the stator of the housing, a second portion exposed out of the stator and with a lead screw formed in an outer periphery thereof, and first and second global portions shaped as a semi-globe at both ends thereof;
a holder arranged in a portion of the rotary shaft where the lead screw is formed, and for performing point contact with the second ball;
a bracket for fixing the holder;
a first guide hole perforated in the housing on a line extended from the rotary shaft to the first global portion;
a thrust guide fixed within the housing, and having a second guide hole perforated in a position corresponding to the first guide hole at a distance therefrom;
a thrust bearing having both ends movably inserted into the first and second guide holes, and performing point contact with the first global portion of the rotary shaft; and
an elastic member arranged in the thrust bearing for applying elastic force to the thrust bearing so that the thrust bearing elastically supports the first global portion.

7. The stepping motor in accordance with claim 6, wherein the thrust bearing has a dent portion, wherein the first global portion of the rotary shaft is inserted into the dent portion to perform point contact therewith.

8. The stepping motor in accordance with claim 6, wherein the thrust bearing has a flange in a central outer periphery which does not contact with the first or second guide hole.

9. The stepping motor in accordance with claim 6, wherein the elastic member comprises a spring washer which has a central through-hole corresponding to the first guide hole and an outer periphery contacting with an inner surface of the housing, wherein the through-hole has a periphery contacting with one end of the thrust bearing for applying elastic force thereto.

10. A stepping motor comprising:
a cylindrical magnet;
a rotary shaft coupled, at one end, with a center of the cylindrical magnet, and having a lead screw in a portion adjacent to the other end;
a having a coil and a yoke and surrounded by a housing and a cover plate, the stator rotatably supporting the rotary shaft in a central portion thereof via a bearing;
a first guide hole perforated in the housing corresponding to an axial line of the rotary shaft;
a thrust guide fixed within the housing, and having a second guide hole perforated in a position corresponding to the first guide hole at a distance therefrom;
a thrust bearing having upper and lower ends movably inserted into the first and second guide holes, respectively, the lower end having a dent portion performing point contact with a terminal end of the rotary shaft; and
a spring washer having one end supported to the housing and the other end supported to the thrust bearing so that the thrust bearing elastically presses the rotary shaft.

11. The stepping motor in accordance with claim 10, wherein the thrust bearing has a flange in a central outer periphery thereof, the flange being adapted to catch the other end of a spring washer.
